(19) United States
(12) Patent Application Publication
(10) Pub. No.: US 2014/0224949 A1
(43) Pub. Date: Aug. 14, 2014

(54) Track Guard

(71) Applicants: Dale Mark, Chicago, IL (US); Paul Terry, Chicago, IL (US)

(72) Inventors: Dale Mark, Chicago, IL (US); Paul Terry, Chicago, IL (US)

(21) Appl. No.: 14/180,019

(22) Filed: Feb. 13, 2014

Related U.S. Application Data
(60) Provisional application No. 61/763,967, filed on Feb. 13, 2013.

(51) Int. Cl. E05F 7/00

(52) U.S. Cl. CPC E05F 7/00
USPC 248/200

(57) ABSTRACT

The invention provides a device for mounting to the bottom of a garage door track to prevent the garage door from being pried open with a pry bar. The device comprises a bracket having a squared “Z” configuration comprising a garage wall mounting plate, a buttressed elongate portion and a track edge support.

### CLAIM OF PRIORITY

This patent application claims priority under 35 USC 119 (e) (1) from U.S. Provisional Patent Application Ser. No. 61/763,967 filed Feb. 13, 2013, of Paul Terry and Dan Mark entitled, “Track Guard.”

### FIELD OF THE INVENTION

This invention relates generally to a track guard and, more particularly, the invention relates to a track guard providing a bracket mount for insertion onto the tracks of garage doors.

### BACKGROUND OF THE INVENTION

### Description of the Prior Art

Originally designed as a simple shelter for an automobile, the garage has evolved to become a vital and active space in many homes. Since most homeowners still utilize their garage to provide shelter for their automobiles or other personal vehicles, most garage designs still feature wide, often cumbersome overhead rolling doors. These doors are constructed of such heavy duty materials because they serve as relatively impenetrable barriers to protect vehicles, as well as expensive tools, bicycles, and other valuable household items stored in the garage, from the elements and from theft. Yet, as strong as garage doors are, they can be no match for a smart, enterprising thief. Although exact statistics germane to just garage break-ins are not available, many metropolitan areas and smaller municipalities are reporting a crafty new means by which criminals are accessing locked garages and cleaning them out. Entry is being made by the suspect using a pry bar at the bottom panel of the garage door, just to the side of the center line. With the created gap, the perpetrator uses some sort of a wire or hook to can snag the release cord for the garage door opener. He is then able to swiftly swipe lawn care equipment, tools, and even cars, and is able to close and relock the garage door when he leaves. If the garage door opener has a spring loaded release cord, it can reconnect when the suspect closes the door. Unfortunately, this slick method of larceny can go unheard, and undetected, until it is too late, costing both homeowners and businesses countless dollars in stolen property.

### BRIEF DESCRIPTION OF THE DRAWINGS

FIG. 1 is a perspective view illustrating a track guard bracket, constructed in accordance with the present invention.

FIG. 2 is a perspective view showing the track guard as installed from the inside vantage from a typical garage door track. This view demonstrates that once installed, the track guard resists displacement of the garage door track.

FIG. 3 is a perspective view showing the track guard as installed as viewed from the outside vantage from a typical garage door track. The track guard is properly installed by mounting one end to the inside wall of the garage door opening and fastening the side of the track guard to the garage door track. Once installed the track guard resists displacement of the garage door track by pry bars or other means of forced entry.

### DETAILED DESCRIPTION OF THE PREFERRED EMBODIMENTS

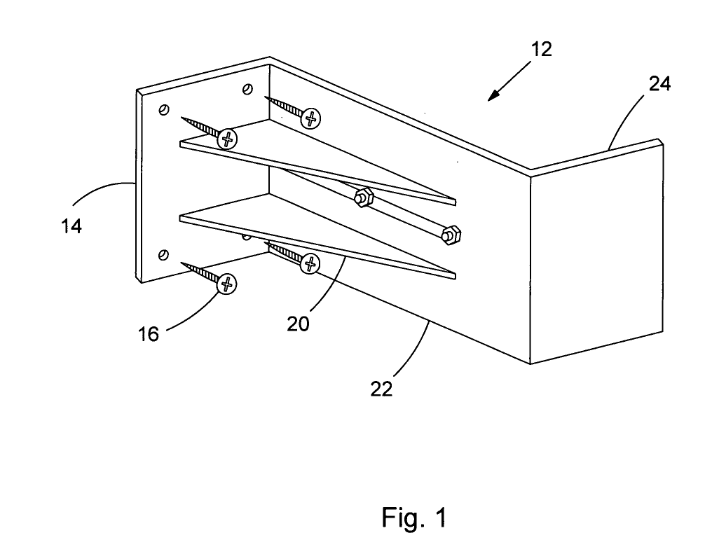

As illustrated in FIGS. 1-3, the present invention is a track guard providing bracket mounts fastening one end to the wall of the garage door opening and fastening the side onto the tracks of garage doors.

FIG. 1 shows the track guard bracket 12 which when fastened, serves to stabilize the garage door track and roller pins.

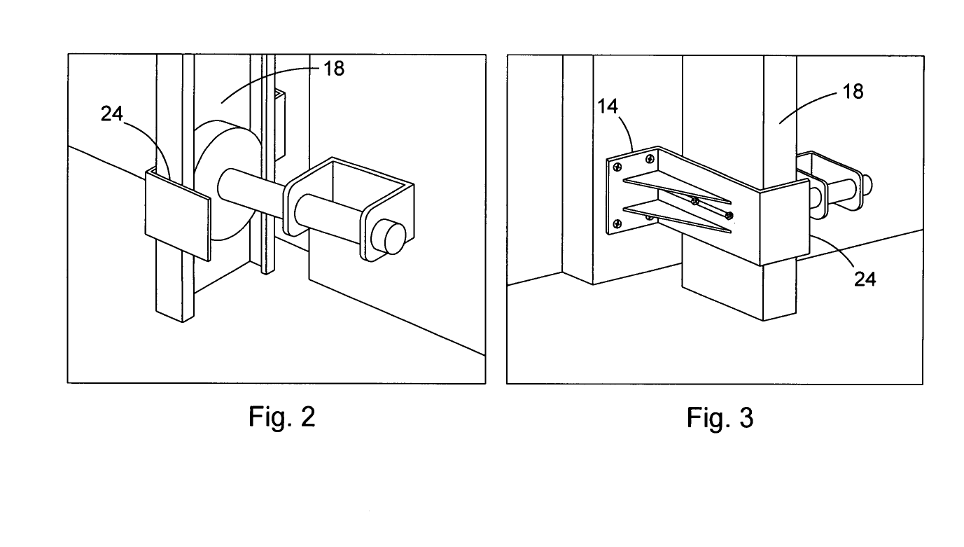

FIG. 2 shows the inside of the garage door track with lifting mechanism, with the track guard of the present invention being mounted on the wall of the garage, and against the back of the track, and extending over the edge of the track to prevent the track from being dislodged by a pry bar or similar mechanism.

Please refer to the Figures. The track guard 12 of the present invention comprises a squared Z-shape configuration, wherein the top and the bottom of the “Z” are at right angles to the elongate central portion. The device of the present invention comprises an essentially square garage wall mounting plate 14, which is mounted to the garage wall by four bolts 16. At a right angle to this garage wall mounting plate 14 extends elongated bracket 22, which is supported by two parallel buttresses 20. Elongated bracket 22 extends from garage wall mounting plate 18 and terminates at a right angle in track edge support 24, which support 24 stabilizes the track 18 and prevents the track 18 from being displaced.

The track guard of the present invention prevents pry bar access and thus any breach of the garage's security. Fabricated from heavy duty, galvanized steel material, the track guard is a three-dimensional, square-to-rectangular unit, measuring approximately four inches (4″) in length, two and one half inches (2½″) in squared height, five inches (5″) in width, and four inches (4″) in depth. For installation, the track guard has a series of bolts or lag screws. A typical lag screw is a 3-inch-long, half-inch-diameter screw with the coarse threads of a wood-screw or sheet-metal-screw thread form and thus appropriate for such a heavy duty product. Additionally, a collection of standard bolts for the garage door track is made available with the track guard. Relatively simple in design yet extremely effective in application, use of the track guard is very easy and straightforward. Following package instructions, the product is mounted onto the bottom section of the existing garage door vertical track and jamb with the hardware provided. Essentially erecting a bar onto the track, the guard prevents the track, as well as the door itself, from being pried with the sturdiest of bars. In this manner, unauthorized access to the garage is denied and the contents of the interior remains safely in place.

The track guard provides garage owners a number of important benefits and advantages. Foremost, this simplified yet incredibly durable piece of hardware offers a highly effective means of reinforcing the security of garage doors. Specifically designed to prevent the using of a pry bar to bend open the door along the bottom track line, the track guard serves as an impenetrable lock against what today's would-be thieves consider to be a smart maneuver. Instantly denied access to a locked garage, criminals likely give up the break-in attempt rather quickly, and the track guard thus prevents them from damaging the garage track. As such, owners are not only spared the loss of property, but can also eliminate the risk of costly garage door assembly repairs. Universal in design, the track guard is appropriate for any garage, whether a two-car shelter for a home or a multi-bay establishment used by an auto repair business. With simple hand tools and easy-to-follow instructions, the track guard can be installed in a matter of minutes. Additionally, the implementation of the track guard does not compromise the regular operation of garage doors, facilitating unimpeded access for those authorized to enter.

The track guard of the present invention readily enhances the security of garages the world over. Preventing damage and thwarting thievery, the guard proves a valuable addition to the security hardware market.

The foregoing exemplary descriptions and the illustrative preferred embodiments of the present invention have been explained in the drawings and described in detail, with varying modifications and alternative embodiments being sought. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. A track guard device for preventing a garage door from being pried open comprising a device having squared Z-shape configuration, wherein the top and the bottom of the “Z” are at right angles to the elongate central portion and wherein the top of the “Z” forms an essentially square garage wall mounting plate, and an elongate portion of the “Z” extends from one side of the garage wall mounting plate at a right angle from the garage wall mounting plate, and wherein two parallel buttresses support the right angle formed by the garage wall mounting plate and the elongate portion, further comprising a track edge support which is connected to the elongate portion at a right angle to the elongate portion at the end of the elongate portion opposite the end of the elongate portion which connects to the garage wall mounting plate.

2. The track guard device of claim 1 wherein the garage mounting plate is mounted to a garage wall by four lag screws or bolts.
